(19) United States
(12) Patent Application Publication
(10) Pub. No.: US 2014/0222758 A1
(43) Pub. Date: Aug. 7, 2014

(54) Coherent File State Maintained Among Confederated Repositories By Distributed Workspace Apparatuses Backed Up By a File State Ledgerdemain Store

(71) Applicants: Roger March, Santa Clara, CA (US); Shivinder Singh Sikand, Soquel, CA (US)

(72) Inventors: Roger March, Santa Clara, CA (US); Shivinder Singh Sikand, Soquel, CA (US)

(73) Assignee: IC MANAGE, INC., Campbell, CA (US)

(21) Appl. No.: 14/138,663

(22) Filed: Dec. 23, 2013

Related U.S. Application Data
(63) Continuation-in-part of application No. 12/541,883, filed on Aug. 14, 2009.

(51) Int. Cl. G06F 17/30

(52) U.S. Cl. CPC G06F 17/30309; G06F 17/30091
USPC 707/638; 707/822

(57) ABSTRACT

Each one of many networked user workstation apparatuses may commit a file into the variant controlled file system by storing a version tracking record for each change log and content point for each block of the file into its local file system view store, and transmitting a version tracking record to a network attached file state ledgerdemain store. Each user workstation displays a file system view of every variant of every file in the file system for selection. When required, the workstation applies change logs to content points according to first a local file system view store for a version tracking record, then requesting and comparing version tracking records from confederated repositories at other user workstation apparatuses, and if unsatisfied, obtains a version tracking record from a network attached file state ledgerdemain store.

### RELATED APPLICATIONS

The present application is a Continuation in Part application of Ser. No. 12/541,883 publication US20110040788 Coherent File State System Distributed Among Workspace Clients filed Aug. 14, 2009 which is incorporated by reference in its entirety.

### BACKGROUND

As has been appreciated by document and software authors and maintainers, Revision control, also known as version control and source control (and an aspect of software configuration management), is the management of changes to documents, computer programs, large web sites, and other collections of information. Changes are usually identified by a number or letter code, termed the “revision number”, “revision level”, or simply “revision”. For example, an initial set of files is “revision 1”. When the first change is made, the resulting set is “revision 2”, and so on. Each revision is associated with a timestamp and the person making the change. Revisions can be compared, restored, and with some types of files, merged.

Revision control is a diverse field, so much so that it is referred to by many names and acronyms. Other descriptions of the related subject matter includes:

Revision control (RCS), Software configuration management (SCM), or configuration management, Source code management, Source code control, or source control, and Version control (VCS)

Revision control is the process of managing multiple versions of a piece of information. In its simplest form, this is something that many people do by hand by modifying a file, saving it under a new name that contains a number, each one higher than the number of the preceding version.

At the simplest level, writers may retain multiple copies of the different versions of the electronic document, and name them appropriately. This approach has been used on many large projects. While this method can work, it is inefficient as many near-identical copies have to be stored. This also requires self-discipline, and often leads to mistakes. Consequently, it is known that systems to automate some or all of the revision control process have been developed.

Manually managing multiple versions of even a single file is an error-prone task, though, so software tools to help automate this process have long been available. The earliest automated revision control tools were intended to help a single user to manage revisions of a single file.

Revision control systems are often centralized, with a single authoritative data store, the repository, and check-outs and check-ins done with reference to this central repository. Alternatively, in distributed revision control, no single repository is authoritative, and data can be checked out and checked into any repository. When checking into a different repository, this is interpreted as a merge or patch.

The second generation moved to network-centered architectures, and managing entire projects at a time. As projects grew larger, they ran into new problems. With clients needing to access servers very frequently, server scaling became an issue for large projects. An unreliable network connection could prevent remote users from being able to access the server consistently. The current generation of revision control tools are trending toward expanded decentralized operations. Many systems have dropped the dependency on a single central server, and allow people to distribute their revision control data. Collaboration over the Internet has moved to a matter of choice and consensus. Modern tools can operate offline indefinitely and autonomously, with a network connection only needed when retrieving or synching changes with another repository.

Over the past few decades, the scope of revision control tools has expanded greatly; they now manage multiple files, and help multiple people to work together. The best modern revision control tools have no problem coping with thousands of people working together on projects that consist of hundreds of thousands of files.

Large, complex projects with many authors and users need a Version Control System to track changes and avoid general chaos. VCS provides some of the following functions: Backup and Restore, Synchronization, Short-term undo, Long-term undo, Track Changes, ie. recording messages explaining why the change happened (stored in the VCS, not the file) to see how a file is evolving over time, and why, Track Ownership. A VCS tags every change with the name of the person who made it, Sandboxing, to make temporary changes in an isolated area, test and work out the kinks before “checking in” changes, Branching and merging, to branch a copy of code into a separate area and modify it in isolation (tracking changes separately), and merge proven work back into the common area.

Most version control systems involve the following concepts, though the labels may be different: Basic Setup, Repository (repo): The database storing the files, Server: The computer storing the repo, Client: The computer connecting to the repo, Working Set/Working Copy: a local directory of files, where changes are made, Trunk/Main: The primary location for code in the repo.

Basic Actions desired for a version control system include:

Add: Put a file into the repo for the first time, i.e. begin tracking it with Version Control, Revision: Noting which version a file is on (v1, v2, v3, etc.); Head: The latest revision in the repo; Check out: Download a file from the repo; Check in: Upload a file to the repository (if it has changed). The file gets a new revision number, and people can “check out” the latest one; Checkin Message: A short message describing what was changed; Changelog/History: A list of changes made to a file since it was created; Update/Sync: Synchronize files with the latest from the repository; Revert: Throw away recent local changes and reload the latest version from the repository.

Advanced Actions sometimes refer to: Branch: Create a separate copy of a file/folder for private use (bug fixing, testing, etc). Branch is both a verb (“branch the code”) and a noun (“Which branch is it in?”); Diff/Change/Delta: Finding the differences between two files; Merge (or patch): Apply the changes from one file to another, to bring it up-to-date; Conflict: mutually exclusive pending changes to a file which contradict each other (both changes cannot be applied); Resolve: arbitrating among the changes that contradict each other and checking in the correct version; Locking: Taking control of a file so nobody else can edit it. Some version control systems use this to avoid conflicts. Check out for edit: Checking out an “editable” version of a file. Some VCSes have editable files by default, others require an explicit command.

### Early Control Methods

Typical manual methods include saving files under various names and dates to non-transitory media. However, human errors such as writing over a desired file version or neglecting to save a desired file are common. And loss or destruction of the non-transitory media are unrecoverable failures. And multiple collaborators must email or transfer such versions of files to one another which becomes tedious when teams exceed a minimal threshold, e.g. (n−1)**2>9

The first generation began by managing single files on individual computers. Although these tools represented a huge advance over ad-hoc manual revision control, their locking model and reliance on a single computer limited them to small, tightly-knit teams.

The best known of the old-time revision control tools is SCCS (Source Code Control System), written at Bell Labs, in the early 1970s. SCCS operated on individual files, and required every person working on a project to have access to a shared workspace on a single system. Only one person could modify a file at any time; arbitration for access to files was via locks.

A free alternative to SCCS in the early 1980s was RCS (Revision Control System). Like SCCS, RCS required developers to work in a single shared workspace, and to lock files to prevent multiple people from modifying them simultaneously.

### Centralized Control Architectures

As known to those skilled in the art of installing, managing, and using centralized version control systems, there exist software products which provide services to network connected authors and users.

Conventional centralized revision control systems use a model where all the revision control functions take place on a shared server. If two developers try to change the same file at the same time, without some method of managing access the developers may end up overwriting each other's work. Centralized revision control systems solve this problem in one of two different “source management models”: file locking and version merging.

The simplest method of preventing “concurrent access” problems involves locking files so that only one developer at a time has write access to the central “repository” copies of those files. Once one developer “checks out” a file, others can read that file, but no one else may change that file until that developer “checks in” the updated version (or cancels the checkout).

File locking has both merits and drawbacks. It can provide some protection against difficult merge conflicts when a user is making radical changes to many sections of a large file (or group of files). However, if the files are left exclusively locked for too long, other developers may be tempted to bypass the revision control software and change the files locally, leading to more serious problems.

Most version control systems allow multiple developers to edit the same file at the same time. The first developer to “check in” changes to the central repository always succeeds. The system may provide facilities to merge further changes into the central repository, and preserve the changes from the first developer when other developers check in.

Merging two files can be a very delicate operation, and usually possible only if the data structure is simple, as in text files. The second developer checking in code will need to take care with the merge, to make sure that the changes are compatible and that the merge operation does not introduce its own logic errors within the files.

Centralized version control focuses on synchronizing, tracking, and backing up files. Centralized VCS emerged from the 1970s, when programmers had thin clients sharing mainframes. This model works for backup, undo and synchronization but isn't optimized for branching and merging changes. In practice, branching is often cumbersome, so new features may come as a giant checkin, making changes difficult to manage and untangle if they go awry.

Many projects are undertaken by teams that are scattered across the globe. Remote users who are far from a central server will see slower command execution and perhaps less reliability. Centralized revision control systems attempt to ameliorate these problems with remote-site replication add-ons.

Centralized revision control systems are known to the Applicants to exhibit low scalability. It is known that a centralized system may fail under a load of just a few dozen concurrent users.

In the 1980s, CVS offered the ability to operate over a network connection using a client/server architecture. CVS's architecture is centralized; only the server has a copy of the history of the project. Client workspaces just contain copies of recent versions of the project's files, and a little metadata to tell them where the server is. CVS is probably the world's most widely used revision control system.

[CVS is probably the most widely used revision control tool in the world. It has a centralized client/server architecture. It does not group related file changes into atomic commits, making it easy for people to “break the build”: one person can successfully commit part of a change and then be blocked by the need for a merge, causing other people to see only a portion of the work they intended to do.

As the 1990s progressed, awareness grew of a number of problems with CVS. Subversion echoes CVS's centralized client/server model, but it adds multi-file atomic commits, better namespace management, and a number of other features that make it a generally better tool than CVS.

Perforce has a centralised client/server architecture, with no client-side caching of any data. Perforce requires a command to inform the server about every file intended to edit. Reportedly, the performance of Perforce falls off rapidly as the number of users grows beyond a few dozen. Modestly large Perforce installations may require the deployment of proxies to cope with the load their users generate

### Distributed Control Systems

As known to those skilled in the art of installing, managing, and using distributed version control system, there exist software products such as Monotone, Bitkeeper (1998), Mercurial (2005) and Git (2005).

An improved conventional revision control system is commonly called Distributed Revision Control Systems. Distribution supports users offline or badly connected to a server. Branching becomes inherent. Everyone has commit access. It uses a network of trust. One user model places responsibility on the 2nd submitter to resolve only merge conflicts.

In general a DVCSystem gives each developer a local copy of the entire development history, and changes are copied from one such repository to another. These changes are imported as additional development branches, and can be merged in the same way as a locally developed branch.

Distributed revision control systems (DRCS) take a confederated repository approach, as opposed to the client-server approach of centralized systems. Rather than a single, central repository with which clients must synchronize, each confederated repository's working copy of the codebase is a bona-fide repository. Distributed revision control conducts synchronization by exchanging patches (change-sets) among confederated repositories. This results in some important differences from a centralized system:
No canonical, reference copy of the codebase exists by default; only working copies.
Common operations (such as commits, viewing history, and reverting changes) are fast, because there is no need to communicate with a central server.
Rather, communication is only necessary when pushing or pulling changes to or from other confederated repositories.
Each working copy effectively functions as a remote backup of the codebase and of its change-history, providing inherent protection against data loss

DVCSs require an orthogonal way of thinking about version control. It is not a simple augmentation of additional features. They break the mold of a single, central repository that underlie most VCSs like Subversion and CVS. A distributed VCS is inverted. Each user checks out their own full copy of the repository and commit locally to it. These changes may then be shared with others, often by synching to a canonical repository.

Every “checkout” is actually a full copy of the entire remote repository (all its branches, all its history). This also means that every checkout is a full backup of everything in the history of a project. This enables looking at previous releases, switching branches, exploring the history without any network access.

Because a checkout” is a full-fledged repository each user can do basically everything without a network connection: commit changes, create branches, perform diffs against any other point in the project history, merge, and so forth. Changes become available to the outside world when ready. Working offline provides an additional “staging area” (in local, private repository

In the early 1990s, an early distributed revision control system called TeamWare had no notion of a central repository.

Another ambitious distributed revision control system named Monotone addressed many of CVS's design flaws and has confederated repository architecture, it goes beyond earlier (and subsequent) revision control tools in a number of innovative ways. It determined cryptographic hashes as identifiers, and has an integral notion of “trust” for code from different sources.

Mercurial began life in 2005. While a few aspects of its design are influenced by Monotone, Mercurial focuses on ease of use, high performance, and scalability to very large projects. BUT, even in the best-managed and healthiest organizations, merge conflicts do occur, and Mercurial will require the merging person to resolve the conflict.

BitKeeper is known to work with multiple source repositories, by moving patches from one repository to another. The multiple repository scheme works for large, globally-distributed development teams. The patch management approach handles changes. These changes percolate to an anointed “master” repository. In some embodiments, BitKeeper includes a logging feature. When multiple repositories are in use, BitKeeper logs all changes to a central server.

Git is an open source version control system popularized by the Linux kernel developers. Every Git working directory is a full-fledged repository with complete history and full version tracking capabilities, not dependent on network access or a central server. Git supports rapid branching and merging. A core assumption in Git is that a change will be merged more often than it is written, as it is passed around various reviewers. Branches in git are very lightweight: A branch in git is only a reference to a single commit.

The Git history is stored in such a way that the ID of a particular version (a commit in Git terms) depends upon the complete development history leading up to that commit. Once it is published, it is not possible to change the old versions without it being noticed. The structure is similar to a hash tree, but with additional data at the nodes as well as the leaves. Mercurial and Monotone also have this property.
Distributed version control focuses on sharing changes; every change has a guid or unique id.
Recording/Downloading and applying a change are separate steps (in a centralized system, they happen together).
Distributed systems have no forced structure. You can create “centrally administered” locations or keep everyone as confederated repositories.
push: send a change to another repository (may require permission)
pull: grab a change from a repository

Key Disadvantages Include:
There's not really a “latest version”. Without a central location, there isn't an agreed official latest “stable” release.
There aren't really revision numbers. Every repository has its own revision numbers depending on the changes. Instead, people refer to change numbers. Thankfully, you can tag releases with meaningful names.
Distributed tools are indifferent to the vagaries of your server infrastructure, again because they replicate metadata to so many locations. The reliability of a network will affect distributed tools far less than it will centralized tools.
With a distributed tool, when one network connection goes down, it may not even be noticed.

### TECHNICAL FIELD

The need for a logical way to organize and control revisions has existed for almost as long as writing has existed, but revision control became much more important, and complicated, when the era of computing began. The numbering of book editions and of specification revisions are examples that date back to the print-only era. Today, the most capable (as well as complex) revision control systems are those used in software development, where a team of people may change the same files.

Revision control allows for the ability to revert a document to a previous revision, which is critical for allowing editors to track each other's edits, correct mistakes, and defend against vandalism and spam.

Revision control refers to any kind of practice that tracks and provides control over changes to data. Software developers sometimes use revision control software to maintain documentation and configuration files as well as source code.

As teams design, develop and deploy software, it is common for multiple versions of the same software to be deployed in different sites and for the software's developers to be working simultaneously on updates. Bugs or features of the software are often only present in certain versions (because of the fixing of some problems and the introduction of others as the program develops). Therefore, for the purposes of locating and fixing bugs, it is vitally important to be able to retrieve and run different versions of the software to determine in which version(s) the problem occurs. It may also be necessary to develop two versions of the software concurrently (for instance, where one version has bugs fixed, but no new features (branch), while the other version is where new features are worked on (trunk).

Moreover, in software development, legal and business practice and other environments, it has become increasingly common for a single document or snippet of code to be edited and consumed by a team, the members of which may be geographically dispersed and may pursue different and even contrary interests. Sophisticated revision control that tracks and accounts for ownership of changes to documents and code may be helpful or even indispensable in such situations.

Revision control may also track changes to apparatus configuration files (e.g. latest firmware update). This gives system administrators another way to easily track changes made and a way to restore earlier versions should the need arise.

Revision control manages changes to a set of data over time. These changes can be structured in various ways.

Often the data is thought of as a collection of many individual items, such as files or documents, and changes to individual files are tracked. This accords with intuitions about separate files, but causes problems when identity changes, such as during renaming, splitting, or merging of files. Accordingly, some systems instead consider changes to the data as a whole, which is less intuitive for simple changes, but simplifies more complex changes.

When data that is under revision control is modified, after being retrieved by checking out, this is not in general immediately reflected in the revision control system (in the repository), but must instead be checked in or committed. A copy outside revision control is known as pre-committed or a “working copy”. As a simple example, when editing a computer file, the data stored in memory by the editing program is the working copy, which is committed by saving. Concretely, one may print out a document, edit it by hand, and only later manually input the changes into a computer and save it. For source code control, the working copy is instead a copy of all files in a particular revision, generally stored locally on the developer's computer; in this case saving the file only changes the working copy, and checking into a repository is a separate step.

If multiple people are working on a single data set or document, they are implicitly creating branches of the data (in their working copies), and thus issues of merging arise, as discussed below. For simple collaborative document editing, this can be prevented by using file locking or simply avoiding working on the same document that someone else is working on.

### What is Needed

However, it is known that in a large interdisciplinary engineering project spanning multiple timezones, each participant may require read-only access to thousands of files while retaining write authority to only a few hundred. Some of the files are related in a logical hierarchy while others are related in a physical hierarchy. Many of the files evolve over time and participants may at one time want access to the most recent version of a certain file and at others desire a stable collation. Thus the files that concern one participant will be different from another and multiple versions of a certain file may be appropriate for various roles.

Moreover concentration of files into centralized servers has been observed to increase congestion and lower both accessibility and reliability. Centralized servers require heavier investment in information technology and redundancy while duplicating storage.

Referring now to FIG. 1, it is known that a user 111 operating a workstation 112 may read and write files on a local file store 113 as well as on network attached file stores coupled to workstations 122 and servers 182. Lack of version control, poor security, and excessive disk usage are common byproducts of this architecture. Substantial congestion has been observed if all files are exclusively stored in a centralized server.

Thus it can be appreciated that what is needed is coherent management of all files committed to a project with distributed storage and improved data block accessibility.

### SUMMARY OF THE INVENTION

The present invention tracks component usage across both revision space and derivation space. Design reuse is accelerated by propagation of either parent or child objects through multiple designs that utilize a version of the object.

The present invention is optimized to provide variant management rather than merely version control which is essential but not sufficient for integrated hardware-software design control. For any given design, there will typically be a large number of variants or sub-variants that share some common design element. The reasons for these variants include process issues; system bugs, timing and cross talk problems, and changed customer requirements. Propagating the right set of changes to the appropriate variant is the beneficial effect of the present subject matter. In many cases, the work is repeated across multiple variants since there is no easy way to manually apply sets of changes to multiple data sets. This is extremely inefficient and error prone and is often the cause of wasted mask sets in the fab.

Each one of many networked user workstation apparatuses may commit a changed or new file into the variant controlled file system by storing a version tracking record for each change log and content point for each block of the file into its local file system view store, and transmitting a version tracking record to a network attached file state store.

Each user workstation displays a file system view of every variant of every file in the file system for selection. When required, the workstation applies change logs to content points according to first a local file system view store for a version tracking record, then requesting and comparing version tracking records from confederated repositories at other user workstation apparatuses, and if unsatisfied, obtains a version tracking record from a network attached file state store. Each pair of networked user workstation apparatus exchanges updated file system views whenever a block of a file is transferred between them.

When initially committed into a variant controlled file system, each block of a file is a content point, i.e. the data contents at that point in time. Over time, each block may acquire changes, which can be accumulated in a change log. One variant or version of a file is the sum of a set of content points and their respective change logs for each content point. Another variant or version may have the same set of content points but a different set of change logs. Moreover a content point may be updated by applying and storing the results of a change log. The changes in a change log are serialized and applied in order. A content point value may be a fingerprint, a hash, a digital signature, or any metadata that distinguishes a first version of a block from a second version of the same block. Conceptually, a content point is a snapshot, archive, or binary image of a file block taken at a specific time. When variants begin to diverge incompatibly, an automated process may take a new content point at the last point of commonality and synthesize parallel change logs to track the divergence.

The present invention comprises a system comprising at least one file state server or network store and a plurality of network attached workspace client apparatuses each with local store containing a file system view. A key aspect of the present subject matter is automatic change propagation between any and all components in an incremental fashion. This enables a file, or set of files, to change names and directory structure across any dataset boundary and back again as many times as necessary, while still referring to the same objects. This allows the producers of the data to be decoupled from the low-level implementation requirements, which is a key issue for streamlined and de-centralized development.

The present invention comprises a method for operating the file state server by receiving an update to a version tracking record from each workspace client apparatus whenever a new or modified file is committed into a file system view, transmitting a version tracking parameter to a workspace client apparatus in response to a query as to the data freshness of a certain file in a file system view, and in an embodiment, updating a workspace client apparatus with a list of confederated repository workspace client apparatuses.

Another aspect of the present invention is a computer-performed method for operating the workspace client apparatus using the steps: transmitting a content point value and a change log serial value to a file state server for each managed file when it is committed, requesting a content point value and a change log serial value from a file state server for each managed file when it is read, determining at least one storage location of a change log and a content point of a file, and retrieving a block of a file consistent with a content point and a change log consistent with a change log serial value and applying changes to the block if necessary.

The present invention comprises a method for operating the workspace client apparatus by: aging files in a file system view and removing the least recently used file from local store, exchanging file system views with confederated repository workspace client apparatuses, updating a list of confederated repository workspace client apparatuses if needed, requesting a data block from a confederated repository workspace client apparatus if a suitable version is not locally stored, transmitting a version tracking parameter to a file state server for each new or modified file committed into a file system view by a user, and querying a file state server for a version tracking parameter for each data block read request from a user operating the workspace client apparatus.

The present invention is a method for operating a system using the steps: within each workspace client apparatus, exchanging with other workspace clients file information, responding to requests for managed file from a workstation, presenting a file system view to a user, updating a file state server with state information for each file in the file system view; within a file state server apparatus, receiving and serving file state information, stashing redundant file copies at workspace clients which do not have a file state view of them, and writing every version of every managed file into archive store.

In an embodiment the method further has the steps: receiving, storing, retrieving and serving a hierarchical tree of data blocks comprising data blocks which are encrypted and data blocks which are not encrypted whereby a file system view circuit can provide its confederated repositories with data blocks which the file system view circuit cannot itself decipher for its own use.

In an embodiment the method for committing a file includes the following processes: making a file visible to all confederated repositories, archiving a file to a central store, updating a file state server with a new version control parameter, and updating a file system view of the file from pre-managed to managed.

### BRIEF DESCRIPTION OF DRAWINGS

FIG. 1 is a block diagram of a conventional system operating over a network provided as background.

FIGS. 2, 3, 4, 5, 6, are data flow diagrams of processes within a block diagram of involved components of a system operating over a network.

FIG. 7 is a hierarchical block diagram of components of apparatus in a system.

FIGS. 8, 9, 10, 11 and 12 are dataflow diagrams between blocks in a system illustrative of steps in a method.

FIG. 13 is a block diagram of components of an apparatus.

FIGS. 14-15 are flowcharts of method steps.

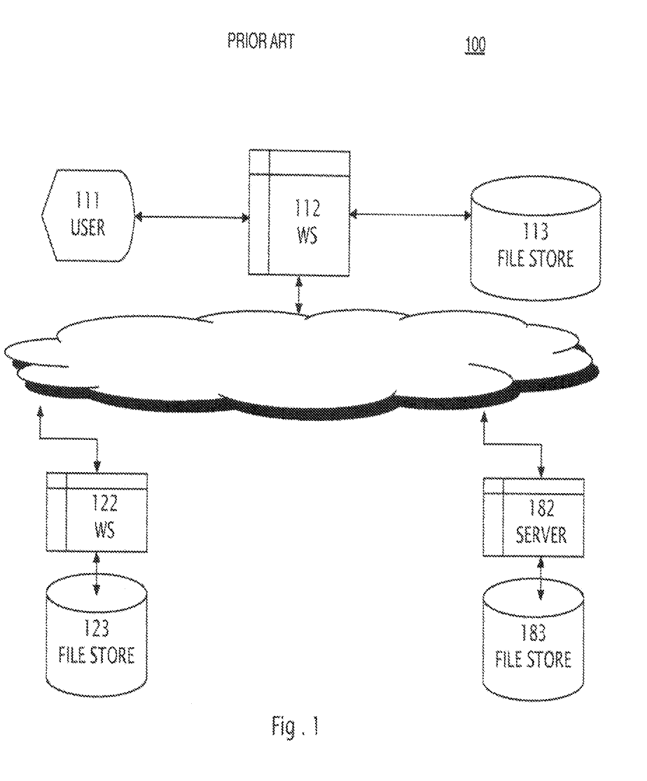

### DETAILED DISCLOSURE OF THE EMBODIMENTS

Each user workstation determines a change log serial and a content point value for every new or changed file committed to the variant file system and stores these into its file system view as version tracking parameters.

Every file block variant can be recovered by applying a change log to a content point when needed.

Each user workstation updates a network connected File State Ledgerdemain Store (FSLS) with version tracking parameters for every variant of every file in its files state view. The FSLS receives and stores version tracking parameters for all the confederated repositories of the user workstations. The FSLS provides a directory of all user workstations which have file system views of repositories. In an embodiment, the FSLS stores all content points and change logs for every version of every variant file. The FSLS provides disaster recovery backup from a remote location for workstations which experience data corruption or failure. The FSLS can direct a user workstation to a file system view of any version of any variant file. We use file state store and file state server as a reference to the FSLS. To avoid congestion, normal operation of the FSLS is to receive and store version tracking parameters from the user workstations. The FSLS is lightweight and it is optimized to record additions and deletions to content points subsequent to the initial file commit. It enables a workstation to identify when its local repository does not have the most recent version of a file block.

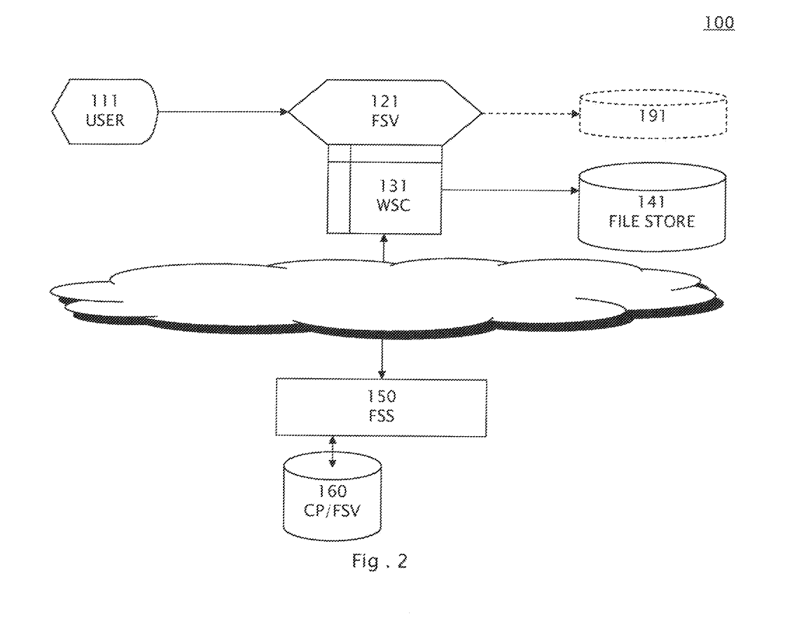

Referring now to FIG. 2, the present invention comprises a workspace client apparatus 131 coupled to a local file store 141, the workspace client apparatus comprising a file state view circuit 121 coupled to a user interface 111. The workspace client apparatus 131 is further coupled through a network to a file state server 150. The file state server comprises a content point store 160 for each file state view for each user.

The method of operating the workspace client apparatus is to present to the user a file system view of a virtual store 191. When a user commits a file in the file system view, the access is intercepted by the workspace client and in an example written to a locally attached file store 141. The workspace client further communicates the change in state to the file system server 150 which records the change in file state in the content point store 160 for this particular user's file state view and archives the new version.

In an embodiment, the workspace client 131 also receives information about its confederated repository workspace clients.

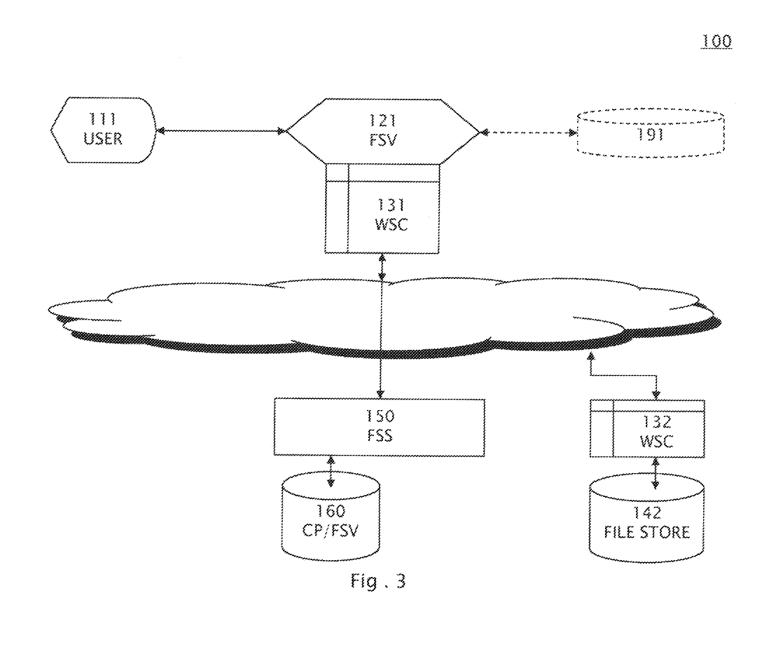

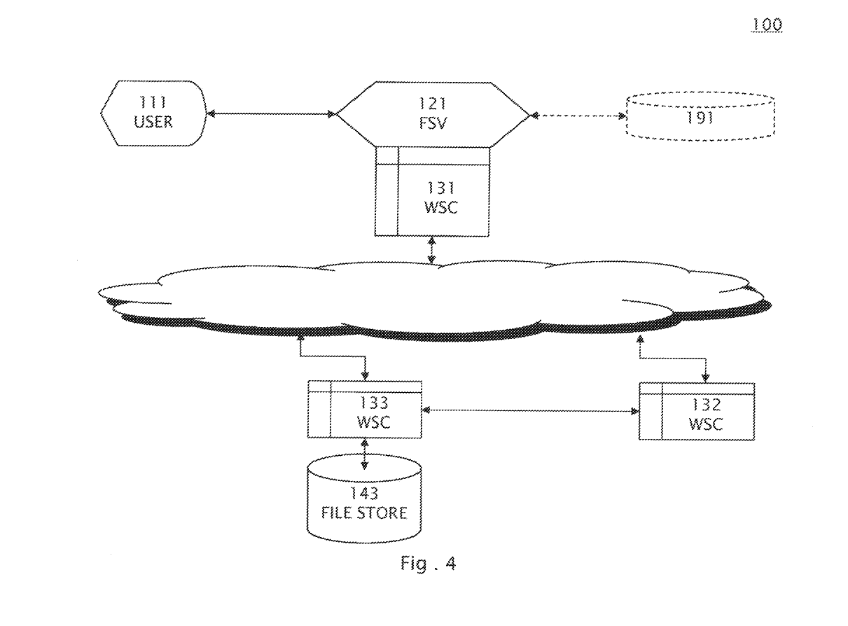

Referring now to FIG. 3, when a user 111 requires a block of a file that is accessible to him according to file state view 121 this access is intercepted and received by the workspace client 131 which queries the file state server for the current content point and change log serial. If not in file store 141, workspace client 131 transfers a request to workspace client 132 and receives the file.

Referring now to figure for 4, the method for operating a workspace client further comprises the step of exchanging further file system view information with confederated repository workspace clients. In this illustration neither workspace client 131 nor workspace client 132 have the file requested by the user however workspace client 132 indicates that the desired file is located in the file store 143 attached to workspace client 133 which is requested and returned.

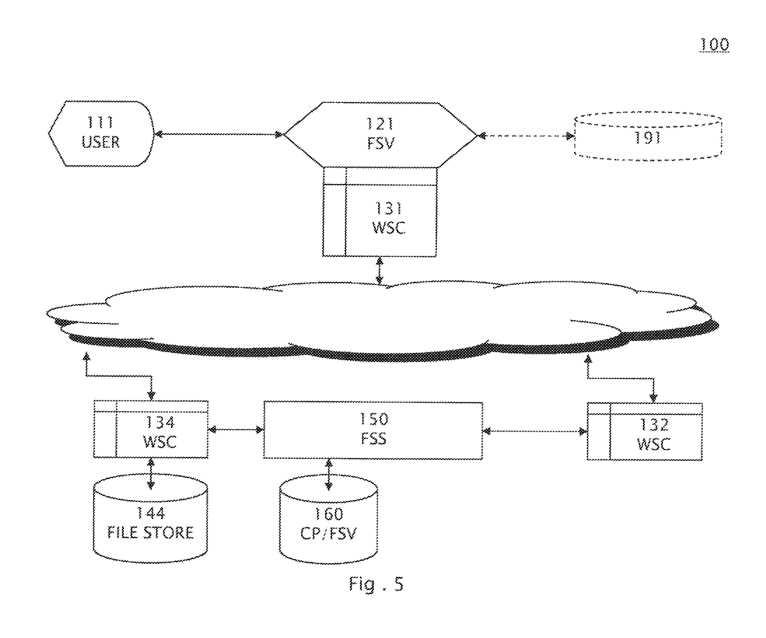

Referring now to FIG. 5, the method for operating a workstation client further comprises the step when no workstation client known to workstation client 131 can locate the requested file, asking the file state server 150 for another workspace client 134 to be queried. Only if unsuccessful in querying confederated repositories will the central archive be accessed.

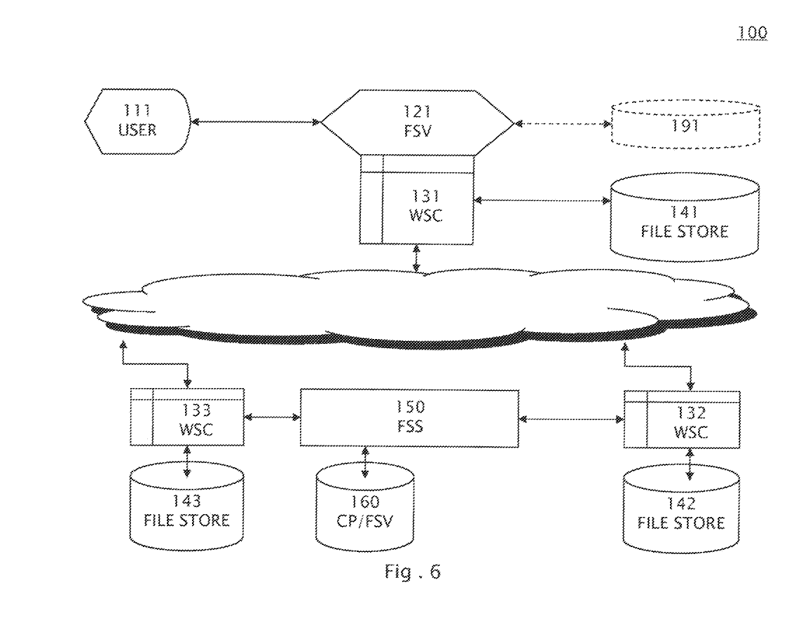

Referring now to FIG. 6, in an embodiment when files are located at a plurality of file stores different pieces of the file can be requested from each file store taking advantage of high-bandwidth to deliver parts of the file simultaneously.

In an embodiment, a workspace client can determine to stash a file locally for redundancy and performance without making the file visible in the file system view of a certain user.

In an embodiment, the file state server can maintain a plurality of content points for different users and control access through the file state views. The workspace client also removes inactive content points which are unneeded by any user i.e. not in its file state view.

In an embodiment the present invention comprises a system for improved serving of versioned files to a plurality of users operating on a shared hierarchical file system comprising a network coupled to at least one file state server apparatus, the network further coupled to a plurality of workspace client apparatuses.

Each workspace client apparatus of the system has a local file store, a network adapter, a user interface, a file system view circuit, wherein the file system view circuit presents to each user a display of his pre-managed files, and managed files visible to all users, wherein managed files comprise change logs and content points.

Such a file state server apparatus has a network adapter, a temporal store, a temporal circuit, and a workspace client store wherein the temporal circuit receives and transmits the change logs and content points of each managed file and which content point are active for each file system view, and wherein the workspace client store receives and transmits the identities and network address of every attached workspace client apparatus.

The present invention in an aspect is a computer-implemented method for operating a system by the steps: within each workspace client apparatus, exchanging with other workspace clients file information, responding to a request for a managed file from a workstation, presenting a file state view to a user, updating a file state server with state information for each file in the file state view.

In an embodiment the present invention comprises a file state server apparatus which has a processor coupled to a plurality of stores and to a network adapter, the processor adapted to maintain the temporal state of files in workspace clients.

In an embodiment, a file state server apparatus also has a file store.

In an embodiment the method for operating file state server comprises: providing likely candidate workspaces to provide the files providing the files from its own file store controlling the access rights for managed files, updating workspace clients about changes in other workspace clients.

In an embodiment the file state server provides a managed file to a workspace client. In an embodiment a workspace client stores redundant file copies which are not presented to a file state view.

The present invention is a method for operating a workspace client apparatus having the following processes: updating managed file information comprising receiving information about workspace clients from other workspace clients receiving information about workspace clients from the file state server presenting a file system view of files managed by the file state server to all users, presenting a file system view of pre-managed files local to the workspace client only to the owner of a pre-managed file, providing managed files to other workspace clients, upon receiving a network request for a managed file from a confederated repository workspace client, examining local file store for requested file, transmitting change log for requested file, transmitting content point for request file, transmitting identities of workspace clients known to have the requested file, exchanging updated file state views of managed files; upon receiving a local user file write storing the file to locally attached file store, if the file is a managed file, determining a change log to a content point, transmitting to a file state server apparatus the current file state, transmitting to a file state server apparatus the file store location, updating the file system view, and archiving a new version of the file; upon receiving a local user file read retrieving the file from locally attached store, if the file is a managed file not in locally attached file store, If possible, satisfies request from within its current holdings If possible, satisfies request from other workspace client, Otherwise, identifying another workspace client.

In an embodiment, the method for operating a workspace client further has the steps: receiving a change log for a file, receiving a content point for a file, receiving and combining file parts from a plurality of sources.

In an embodiment the method for operating a workspace client further includes: optimizing workspace client information exchange maintaining change logs over a finite range exchanging only incremental changes if possible and, otherwise, exchanging full state,

In an embodiment, the method for operating a workspace client further includes: choosing suitable confederated repository workspace clients based on similar file system views to request blocks from, collecting statistics about performance and reliability of other workspace clients to prioritize block requests, and recording the frequency of network link failures to determine redundant resource gaps.

In an embodiment, the network is an encrypted ssl tunnel.

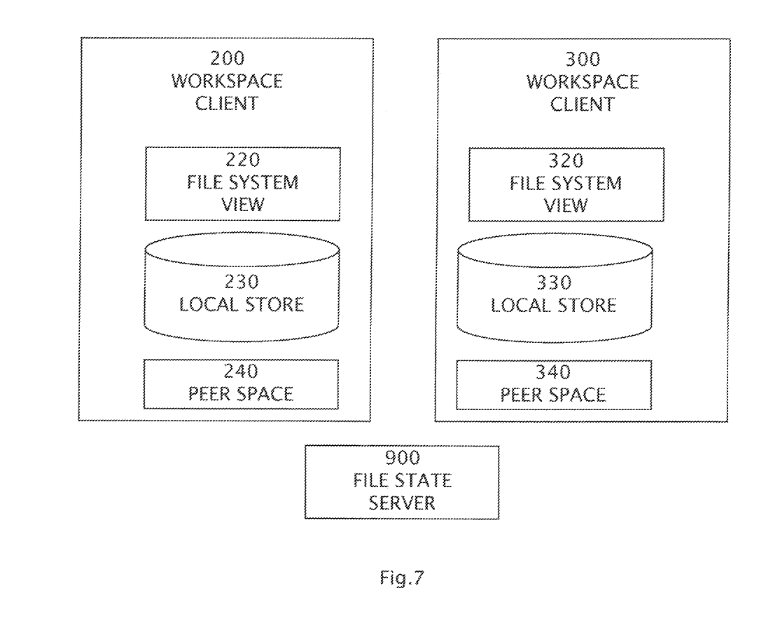

Referring to FIG. 7, an embodiment comprises a file state server 900 and a plurality of workspace client apparatuses 200, 300, . . . each workspace client apparatus has a local store, a file system view circuit, and a confederated repository space circuit.

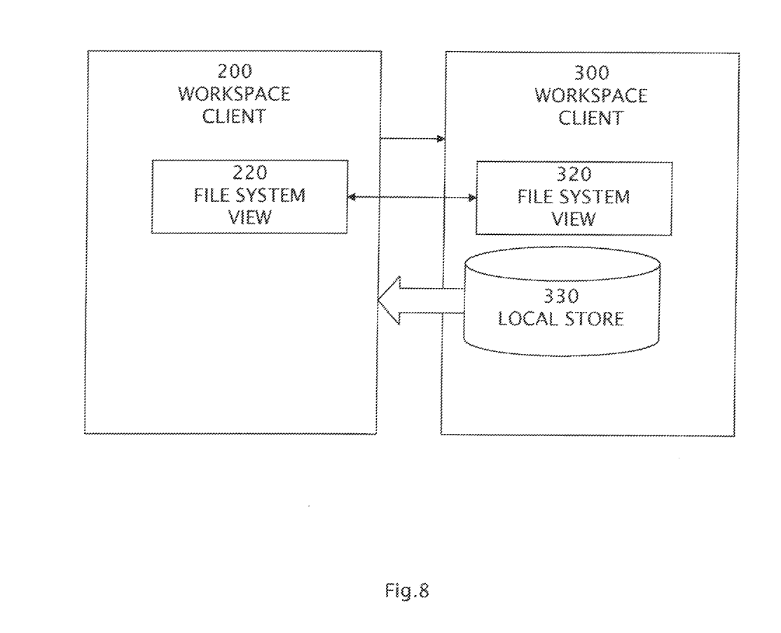

Referring to FIG. 8, a method for operating a workspace client, has the steps following: recording each access by user to each file in file system view, removing least recently used files which are read only, receiving a request from a confederated repository client apparatus for a certain block of a certain file, determining if the requested block is stored in the local store 330, if stored, transmitting the requested block to the confederated repository client apparatus 200, and exchanging file system view updates between the workspace clients.

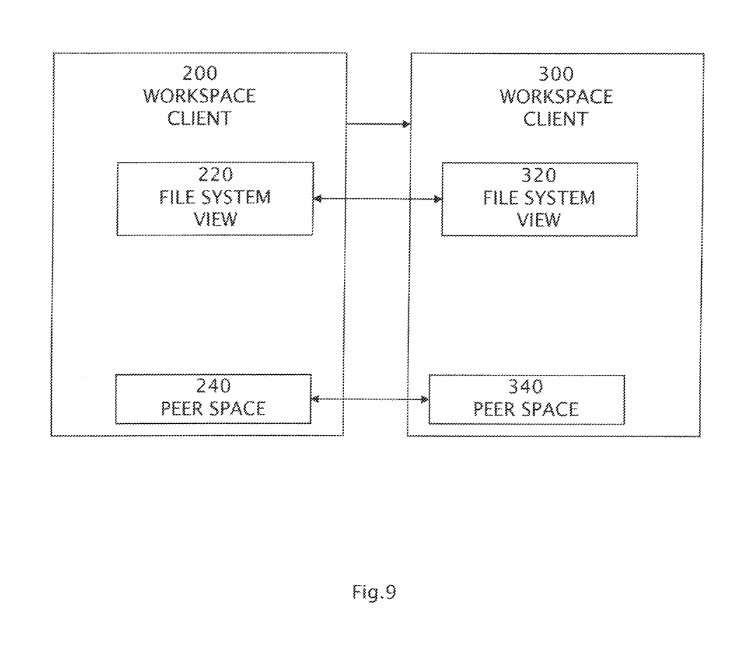

Referring to FIG. 9, in an embodiment, the method further comprises the step of exchanging confederated repository space updates in the case that the workspace client determines that the requested block is not stored in the local store.

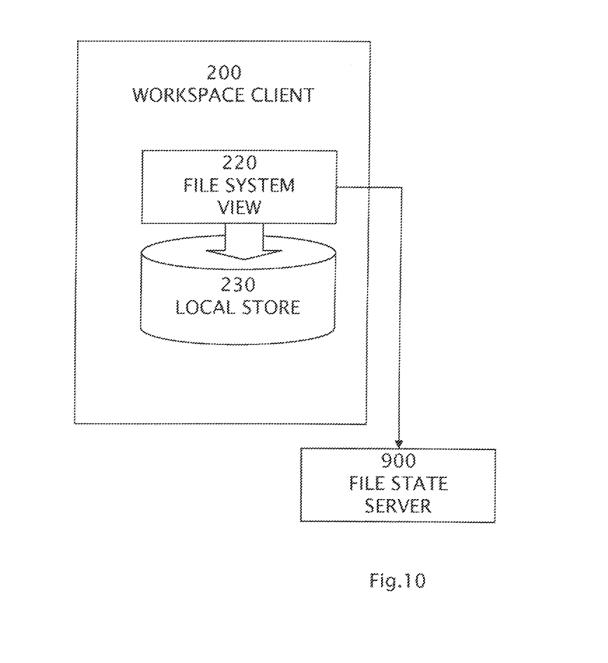

Referring to FIG. 10, a method for operating a system comprising a file state server 900 and a workspace client 200, with the steps: recording each access by a user to a file in file system view, removing from local store least recently used files, committing a new or changed file to local store 230, updating a file system view circuit 220 with a change log or initial content point of the file, and updating a file state server with the status of the new or changed file.

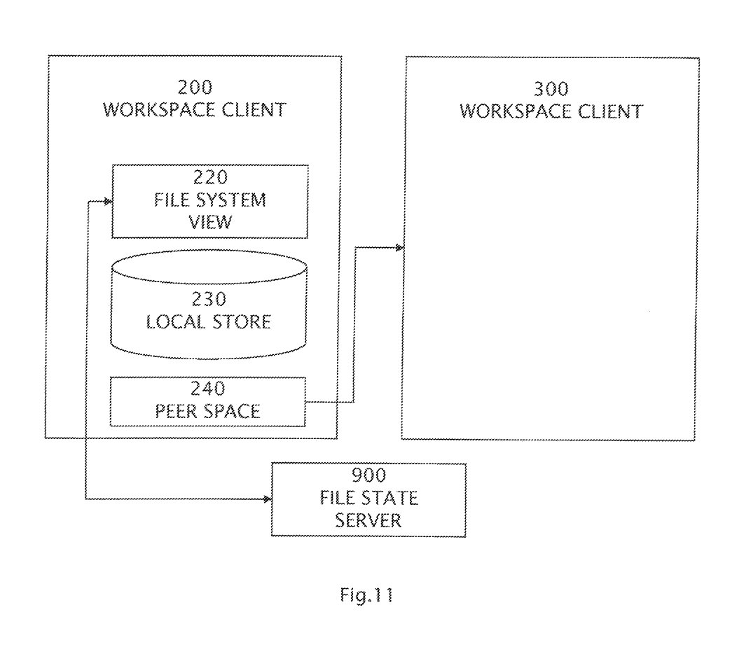

Referring to FIG. 11, the method for operating a system includes the following steps: within a second workspace client 300, receiving a request for a certain block from a confederated repository workspace client 200, within a file state server 900, receiving a request from a first workspace client 200 and transmitting the current status of a certain file; within a first workspace client 200, intercepting at least one file block read requested by a user, requesting a current status of the file from the file state server 900, determining that at least one block of the current file is not within the local store 230, obtaining at least one candidate confederated repository workspace client from a confederated repository space circuit 240, and transmitting a block request to at least one confederated repository workspace client 300.

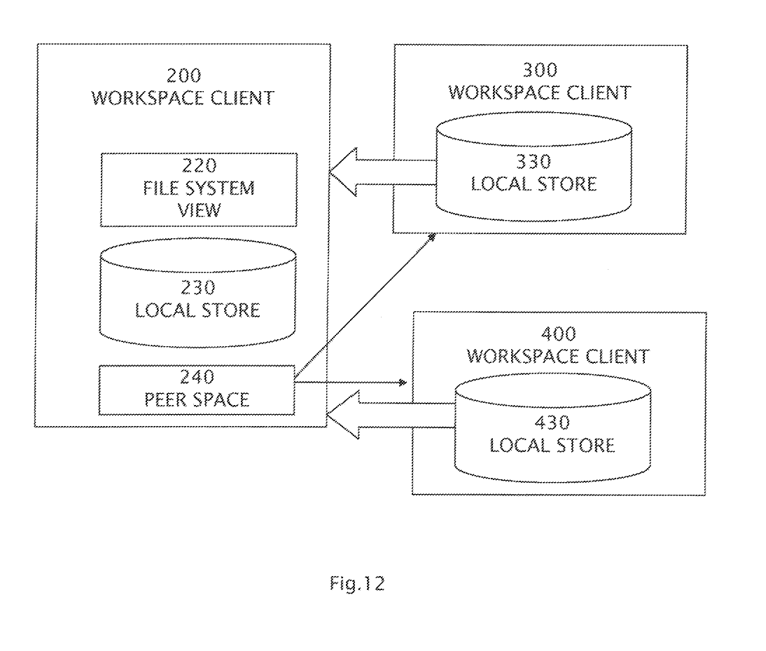

Referring to FIG. 12, in an embodiment, the method further comprises [0138] determining that a first block is not in local store 230 and a second block is not in local store 230, requesting a first block from a first confederated repository workspace client 300; requesting a second block from a second confederated repository workspace client 400; and integrating the blocks for the user of workspace client 200.

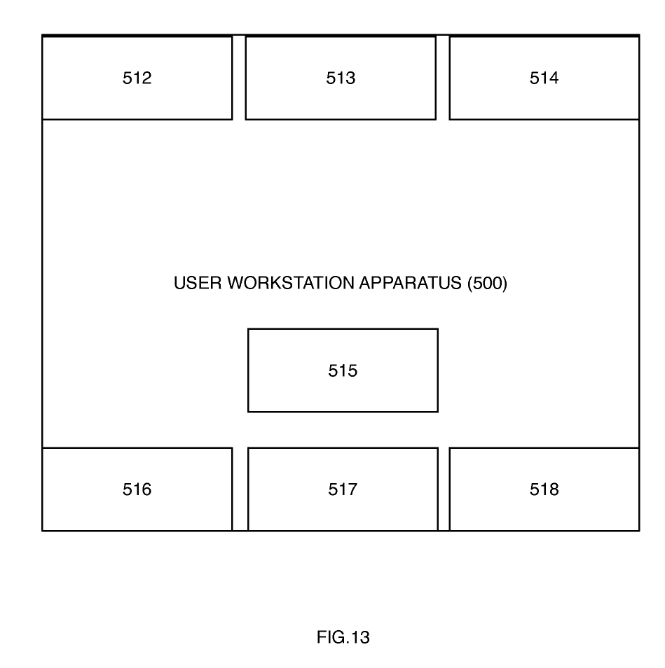

One aspect of the invention is a workstation client apparatus shown in FIG. 13 for coherent management of all files committed to a project with distributed repositories. The apparatus 500 includes a network interface 512, communicatively coupled to the following elements, a repository 513, a file system view circuit 514, a store 515 for file system views of other workstation client apparatuses communicatively coupled, a circuit 516 to determine a change log, change log serial number, content point, and content point value for each file variant, when it is committed into a variant controlled file system, a circuit 517 to receive, and to transmit change logs and content points when a block of a variant file is read, and a circuit 518 to apply a change logs to a content point received from an other workstation client apparatus when the local store does not contain the desired block of a variant file.

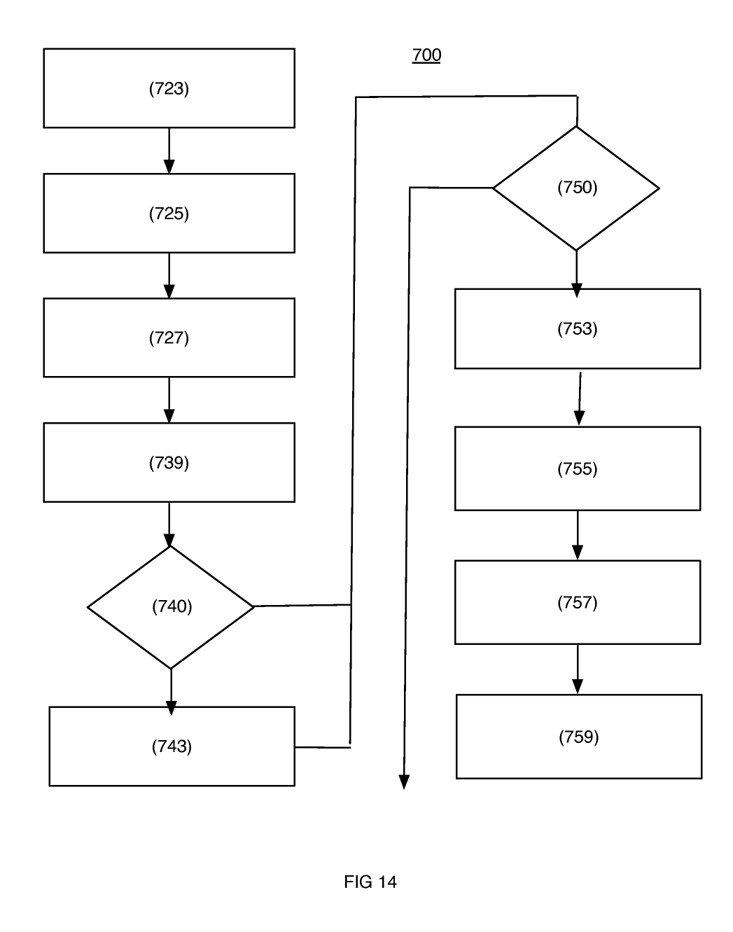

Another aspect of the invention shown in FIG. 14 is a method 700 for operating one of a plurality of workstation apparatuses communicatively coupled on a network, the method comprising: receiving 723 at a first workstation client apparatus from a second workstation client apparatus a request for a block of a variant file selected from a file system view display, determining 725 whether the requested block of a file is stored in a local store of the first workstation client apparatus according to a first file system view of the first workstation client apparatus, and transmitting 727 a change log and content point for the requested block of a file to the second workstation client apparatus if a version tracking parameter matches.

In an embodiment, the method includes: transmitting 739 the first file system view of all variant files stored in the local store of the first workstation client apparatus to the second workstation client apparatus, said first file system view comprising each version tracking parameter of each file block stored in the local store of the first workstation client apparatus.

In an embodiment, the method includes: on the condition 740 that the requested version tracking parameter of a file block does not match any version tracking parameter in the first file system view of the first workstation client apparatus, transmitting 743 to the second workstation client apparatus a third file system view of at least one third workstation client apparatus, said third file system view comprising a version tracking parameter of file blocks stored in a third local store of said third workstation client apparatus.

In an embodiment, the method includes: on the condition 750 that the requested block of a file does not match any version tracking parameter in the first file system view of the first workstation client apparatus, requesting 753 from an other one of the plurality of workstation apparatuses communicatively coupled on the network a content point and change log of a file block requested by the second workstation client apparatus, receiving 755 from other one of the plurality of workstation apparatus peers communicatively coupled on the network the requested charge log and content point, updating 757 the first file system view of the first workstation client apparatus with a version tracking parameter including the block received from the other one of the plurality of workstation apparatus peers communicatively coupled on the network, and transmitting 759 to a file state store the now updated first file system view of the first workstation client apparatus.

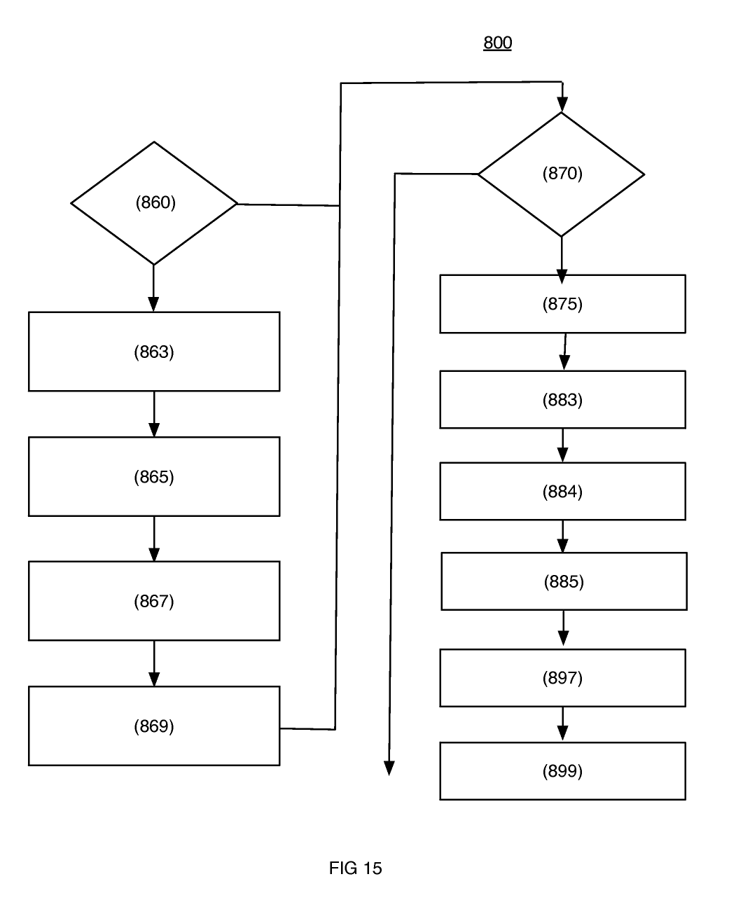

Another aspect of the invention shown in FIG. 15 is a method 800 for operating one of a plurality of user workstation apparatuses communicatively coupled on a network, the method comprising: when a user of a second workstation client apparatus desires to commit a new or modified file into a coherent file system of the plurality of workstation client apparatuses 860, determining 863 a change log, change log serial, content point, and content point value for each block of the file, storing 865 each change log serial and content point value into a file system view of the second workstation client apparatus, transmitting 867 a version tracking parameter to a file state store, and storing 869 each change log and content point for each block of the file into the local store of the second workstation client apparatus, whereby the file state store has an up-to-date copy of the file system view of each communicatively coupled user workstation apparatus.

In an embodiment the method for operating one of a plurality of workstation client apparatus communicatively coupled on a network, the method further includes: on the condition 870 that a file block read request does not match any variant file stored within the file system view of the second workstation, transmitting 875 to a first workstation client apparatus from the second workstation client apparatus a request for a change log and content point which matches the requested version tracking parameter of a file block.

In an embodiment the method for operating one of a plurality of workstation client apparatus communicatively coupled on a network, the method further includes: transmitting 883 at least one content point value and at least one change log serial value to a file state store for each managed file when it is committed into a variant file management system; storing 884 at least one content point and at least one change log to a local repository; and storing 885 a version tracking parameter to a file system view circuit.

In an embodiment the method for operating one of a plurality of workstation client apparatus communicatively coupled on a network, the method further includes: determining 897 at least one storage location of a change log and a content point of a file, and retrieving 899 a content point and a change log consistent with a version tracking parameter and applying changes to the content point.

In an embodiment, the method for operating a file state server with the steps: receiving and storing each change in file system view from each workspace client, responding to a workspace client request with the current versions of each file.

In an embodiment the method further comprises the step of responding to a first workspace client request with at least one confederated repository workspace client not previously known to the first workspace client.

In an embodiment the method for operating a workspace client comprises: committing a file or modified file into a file system view, intercepting a block read request of a certain committed file, requesting the current revision number for a certain committed file from a file state server, determining if local store contains a current revision of a certain committed file, examining file system views of confederated repository workspace clients to locate a current revision of a certain committed file, requesting transfer of a block of a certain committed file from a confederated repository workstation client, recording each access to each file in file system view, and removing from local store a least recently used file.

### CONCLUSION

The present invention is easily distinguished from conventional network file systems and source code control solutions by its file state server which tracks every version of every managed file and its plurality of network attached workspace client apparatuses, which respond to requests for randomly accessible blocks of files among themselves. It can be appreciated that that a conventional network file system has no concept of disjoint file views where each user is concerned with a snapshot of every file at a point in time.

The present invention is distinguished from conventional source code control solutions by operating the file state server to receive an update to a version tracking record from each workspace client apparatus whenever a new or modified file is committed into a file system view, and to transmit a version tracking parameter to a workspace client apparatus in response to a query as to the data freshness of a certain file in a file system view. In an embodiment, the file state server provides a workspace client apparatus with a list of confederated repository workspace client apparatuses. To avoid congestion, queries for a certain file to all confederated repository workspace clients are exhausted before retrieval from a centralized archive store. The present invention is easily distinguished from conventional source code control systems by averting massive duplication of files among every user of each file.

The present invention is distinguished from conventional confederated repository to confederated repository file sharing by operating the workspace client apparatus to age files in a file system view and remove the least recently used file from local store, to exchange file system views with confederated repository workspace client apparatuses, to update a list of confederated repository workspace client apparatuses if needed, to request a data block from a confederated repository workspace client apparatus if a suitable version is not locally stored, to transmit a version tracking parameter to a file state server for each new or modified file committed into a file system view by a user, to allow selectable access to every version of every managed file, and to query a file state server for a version tracking parameter for each data block read request from a user operating the workspace client apparatus.

It is a distinguishing characteristic that workspace clients respond to requests for randomly accessed data blocks rather than whole file transfers and that workspace clients request version tracking parameters from a file state server before fulfilling data reads with local stored data blocks.

The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

A number of embodiments of the invention have been described. Nevertheless, it will be understood that various modifications may be made without departing from the spirit and scope of the invention. For example, other network topologies may be used. Accordingly, other embodiments are within the scope of the following claims.

We claim:

1. A workstation client apparatus for coherent management of all files committed to a project with distributed repositories, said apparatus comprising:
a network interface, communicatively coupled to the following elements,
a repository,
a file system view circuit,
a store for file system views of other workstation client apparatuses communicatively coupled,
a circuit to determine a change log, change log serial number, content point, and content point value for each file variant, when it is committed into a variant controlled file system,
a circuit to receive, and to transmit change logs and content points when a block of a variant file is read, and
a circuit to apply a change logs to a content point received from an other workstation client apparatus when the local store does not contain the desired block of a variant file.

2. A method for operating one of a plurality of workstation apparatus peers communicatively coupled on a network, the method comprising:
receiving at a first workstation client apparatus from a second workstation client apparatus a request for a block of a variant file selected from a file system view display,
determining whether the requested block of a file is stored in a local store of the first workstation client apparatus according to a first file system view of the first workstation client apparatus, and
transmitting a change log and content point for the requested block of a file to the second workstation client apparatus if a version tracking parameter matches.

3. The method of claim 2 further comprising:
transmitting the first file system view of all variant files stored in the local store of the first workstation client apparatus to the second workstation client apparatus, said first file system view comprising each version tracking parameter of each file block stored in the local store of the first workstation client apparatus.

4. The method of claim 3 further comprising:
on the condition that the requested version tracking parameter of a file block does not match any version tracking parameter in the first file system view of the first workstation client apparatus,
transmitting to the second workstation client apparatus a third file system view of at least one third workstation client apparatus, said third file system view comprising a version tracking parameter of file blocks stored in a third local store of said third workstation client apparatus.

5. The method of claim 3 further comprising:
on the condition that the requested block of a file does not match any version tracking parameter in the first file system view of the first workstation client apparatus,
requesting from an other one of the plurality of workstation apparatuses communicatively coupled on the network a content point and change log of a file block requested by the second workstation client apparatus,
receiving from other one of the plurality of workstation apparatuses communicatively coupled on the network the requested charge log and content point,
updating the first file system view of the first workstation client apparatus with a version tracking parameter including the block received from the other one of the plurality of workstation apparatuses communicatively coupled on the network, and
transmitting to a file state ledgerdemain store the now updated first file system view of the first workstation client apparatus.

6. A method for operating one of a plurality of user workstation apparatuses communicatively coupled on a network, the method comprising:
when a user of a second workstation client apparatus desires to commit a new or modified file into a coherent file system of the plurality of workstation client apparatuses,
determining a change log, change log serial, content point, and content point value for each block of the file,
storing each change log serial and content point value into a file system view of the second workstation client apparatus,
transmitting a version tracking parameter to a file state ledgerdemain store, and
storing each change log and content point for each block of the file into the local store of the second workstation client apparatus, whereby the file system view store has an up-to-date copy of the file system view of each communicatively coupled user workstation apparatus.

7. The method of claim 6 for operating one of a plurality of workstation client apparatus communicatively coupled on a network, the method further comprising:
on the condition that a file block read request does not match any variant file stored within the file system view of the second workstation,
transmitting to a first workstation client apparatus from the second workstation client apparatus a request for a change log and content point which matches the requested version tracking parameter of a file block.

8. The method of claim 7 further comprising:
transmitting at least one content point value and at least one change log serial, value to a file state ledgerdemain store for each managed file when it is committed into a variant file management system;
storing at least one content point and at least one change log to a local repository; and
storing a version tracking parameter to a file system view circuit.

9. The method of claim 8 further comprising
determining at least one storage location of a change log and a content point of a file, and
retrieving a content point and a change log consistent with a version tracking parameter and applying changes to the content point.
